(19) United States
(12) Patent Application Publication
(10) Pub. No.: US 2026/0279978 A1
(43) Pub. Date: Sep. 17, 2026

(54) EXTERIOR BODY, LAMINATE BATTERY, AND EXTERIOR BODY MANUFACTURING METHOD

(71) Applicant: HONDA MOTOR CO., LTD., Tokyo (JP)

(72) Inventor: Hideaki Sasaki, Wako-shi (JP)

(21) Appl. No.: 19/547,727

(22) Filed: Feb. 24, 2026

(30) Foreign Application Priority Data
Mar. 11, 2025 (JP) 2025-038182

(51) Int. Cl. H01M 50/105

(52) U.S. Cl. CPC H01M 50/105

(57) ABSTRACT

An exterior body is used for a laminate battery, the exterior body including: a protrusion structure having a space for enclosing an electric power generation element, wherein the protrusion structure has a top surface, and the top surface is inclined from a corner portion of a positive electrode mixture part of the electric power generation element toward a corner portion of the exterior body in a side view of the protrusion structure.

### CROSS-REFERENCE TO RELATED APPLICATION

Priority is claimed on Japanese Patent Application No. 2025-038182, filed on Mar. 11, 2025, the contents of which are incorporated herein by reference.

### BACKGROUND

### Field of the Invention

The present invention relates to an exterior body, a laminate battery, and an exterior body manufacturing method.

### BACKGROUND

An exterior body used for a laminate battery has a protrusion structure having a space for enclosing an electric power generation element. In order to deal with the expansion and contraction of the laminate battery, the depth of the protrusion structure is larger than the thickness of the electric power generation element, and four sides and four corners portions (four corners) of the exterior body have an extra length (for example, refer to Japanese Unexamined Patent Application, First Publication No. 2021-96897).

### SUMMARY

However, in the case where the depth of the protrusion structure is larger than the thickness of the electric power generation element and the four corners of the exterior body have an extra length, a wrinkle may be generated on the exterior body when the electric power generation element is sealed by vacuum sealing or at the time of expansion and contraction of the laminate battery. When repeated bending fatigue due to the expansion and contraction of the laminate battery is accumulated in the exterior body, a hole may be formed on the exterior body.

An aspect of the present invention aims at providing an exterior body, a laminate battery, and an exterior body manufacturing method that prevent a hole from being formed due to repetition of expansion and contraction of a laminate battery. The aspect of the present invention contributes to stabilization of battery performances and, consequently, to energy efficiency.

A first aspect of the present invention is an exterior body used for a laminate battery, the exterior body including: a protrusion structure having a space for enclosing an electric power generation element, wherein the protrusion structure has a top surface, and the top surface is inclined from a corner portion of a positive electrode mixture part of the electric power generation element toward a corner portion of the exterior body in a side view of the protrusion structure.

According to the first aspect described above, it is possible to prevent a wrinkle from being generated on the exterior body and improve the durability of the exterior body against fatigue breakdown when expansion and contraction of the laminate battery are repeated. As a result, it is possible to prevent a hole from being formed on the exterior body due to the repetition of the expansion and contraction of the laminate battery.

A second aspect is the exterior body according to the first aspect described above, wherein a corner portion of the protrusion structure may form a taper shape, and the taper shape may be inclined from the corner portion of the positive electrode mixture part of the electric power generation element toward the corner portion of the exterior body in the side view of the protrusion structure.

According to the second aspect described above, it is possible to prevent a wrinkle from being generated on the corner portion of the exterior body and improve the durability of the exterior body against fatigue breakdown when expansion and contraction of the laminate battery are repeated.

A third aspect is the exterior body according to the second aspect described above, wherein a start edge of the taper shape may be the corner portion of the positive electrode mixture part of the electric power generation element.

According to the third aspect described above, it is possible to prevent an end portion of the electric power generation element from coming into contact with the corner portion of the exterior body and prevent the corner portion from being damaged when expansion and contraction of the laminate battery are repeated.

A fourth aspect is the exterior body according to the first aspect described above, wherein the top surface may form a taper shape from the corner portion of the positive electrode mixture part of the electric power generation element toward the corner portion of the exterior body in the side view of the protrusion structure.

According to the fourth aspect described above, it is possible to prevent a wrinkle from being generated on the corner portion of the exterior body and improve the durability of the exterior body against fatigue breakdown when expansion and contraction of the laminate battery are repeated.

A fifth aspect is the exterior body according to the first aspect described above, wherein a depth of the protrusion structure may be 4 mm.

According to the fifth aspect described above, it is possible to prevent the electric power generation element from coming into contact with the exterior body and improve the durability of the exterior body against fatigue breakdown when expansion and contraction of the laminate battery are repeated.

A sixth aspect is the exterior body according to the first aspect described above, wherein a depth of the protrusion structure may be larger than a thickness of the electric power generation element, and the protrusion structure may have an extra length in a side other than a corner portion.

According to the sixth aspect described above, it is possible to prevent the electric power generation element from coming into contact with the exterior body, particularly the corner portion, and improve the durability of the exterior body against fatigue breakdown when expansion and contraction of the laminate battery are repeated.

A seventh aspect is a laminate battery having a first exterior body, a second exterior body, and an electric power generation element enclosed between the first exterior body and the second exterior body, wherein at least one of the first exterior body and the second exterior body is the exterior body according to any one of the first to sixth aspects.

According to the seventh aspect described above, it is possible to prevent a hole from being formed on the exterior body due to the repetition of the expansion and contraction of the laminate battery.

An eighth aspect is an exterior body manufacturing method which is a manufacturing method of the exterior body according to any one of the first to sixth aspects, the exterior body manufacturing method including: forming the protrusion structure by performing a drawing process on a laminate film, wherein a mold used for the drawing process has a shape corresponding to inclination of the top surface of the protrusion structure.

According to the eighth aspect described above, it is possible to manufacture an exterior body that prevents a hole from being formed due to the repetition of the expansion and contraction of the laminate battery.

According to the aspect of the present invention, it is possible to provide an exterior body, a laminate battery, and an exterior body manufacturing method that prevent a hole from being formed due to repetition of expansion and contraction of a laminate battery.

### BRIEF DESCRIPTION OF THE DRAWINGS

FIG. 1 is a plan view showing an exterior body according to an embodiment of the present invention.

FIG. 2 is a cross-sectional view showing the exterior body according to the embodiment of the present invention.

FIG. 3A is a plan view showing a laminate battery according to the embodiment of the present invention.

FIG. 3B is a cross-sectional view showing the laminate battery according to the embodiment of the present invention.

### DESCRIPTION OF EMBODIMENTS

Hereinafter, an embodiment of the present invention will be described in detail with reference to the drawings.

### Exterior body

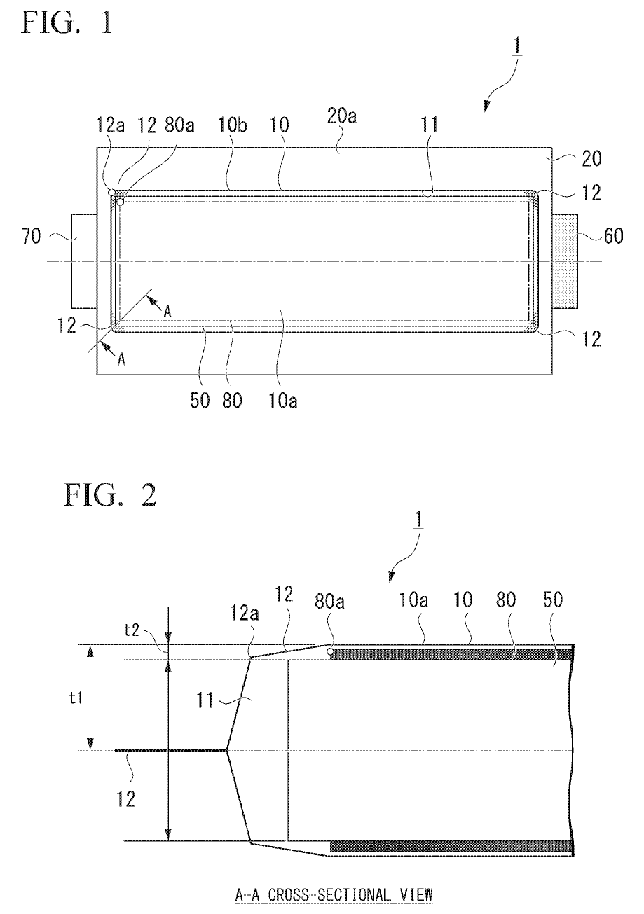

FIGS. 1 and 2 are a cross-sectional view showing an exterior body according to an embodiment of the present invention. In the drawings used in the following description, in order to make characteristics easy to understand, characteristic portions may be shown in an enlarged manner for the sake of convenience, and dimensional ratios or the like of each constituent element are not limited to exemplary examples.

As shown in FIG. 1, the exterior body 1 of the present embodiment includes a protrusion structure 10 and a circumferential edge portion 20.

The protrusion structure 10 protrudes from the circumferential edge portion 20 in a direction perpendicular to the surface 20a of the circumferential edge portion 20 and has a space 11 for enclosing an electric power generation element 50. The protrusion structure 10 has a top surface 10a. The top surface 10a of the protrusion structure 10 is a surface that is located at a position away from the surface 20a of the circumferential edge portion 20 in the direction perpendicular to the surface 20a of the circumferential edge portion 20 in the protrusion structure 10. The top surface 10a of the protrusion structure 10 is inclined from a corner portion of a positive electrode mixture part of the electric power generation element 50 toward a corner portion 12 of the exterior body 1 in a side view of the protrusion structure 10 (when seen from a direction perpendicular to a depth direction of the protrusion structure 10). In other words, the top surface 10a of the protrusion structure 10 is inclined so as to descend toward the circumferential edge portion 20 from a middle portion of the top surface 10a. Thereby, it is possible to prevent a wrinkle from being generated on the exterior body 1 and improve the durability of the exterior body 1 against fatigue breakdown when expansion and contraction of a laminate battery using the exterior body 1 are repeated. As a result, it is possible to prevent a hole from being formed on the exterior body 1 due to the repetition of the expansion and contraction of the laminate battery.

The four corners 12 of the protrusion structure 10 form a taper shape. More specifically, the corner portion 12 forms a taper shape in which a width gradually narrows as a distance from the middle portion of the top surface 10a of the protrusion structure 10 increases. Thereby, it is possible to prevent a wrinkle from being generated on the corner portion 12 of the exterior body 1 due to an extra length becoming absent, and it is possible to improve the durability of the exterior body 1 against fatigue breakdown when expansion and contraction of the laminate battery using the exterior body 1 are repeated.

As shown in FIG. 2, the taper shape of the corner portion 12 is inclined from a corner portion 80a of the positive electrode mixture part of the electric power generation element 50 toward a corner section 12a of the exterior body 1. More specifically, the taper shape of the corner portion 12 is inclined toward the corner section (apex) 12a side of the corner portion 12 of the exterior body 1 as a distance from the middle portion of the top surface 10a of the protrusion structure 10 increases. Thereby, it is possible to prevent a wrinkle from being generated on the corner portion 12 of the exterior body 1 due to an extra length becoming absent, and it is possible to improve the durability of the exterior body 1 against fatigue breakdown when expansion and contraction of the laminate battery using the exterior body 1 are repeated.

As shown in FIG. 2, the depth of the protrusion structure 10, that is, a distance t1 between the circumferential edge portion 20 and the top surface 10a of the protrusion structure 10 in a depth direction of the protrusion structure 10 can preferably be equal to or more than the height of the laminate battery at the time of maximum expansion and can preferably avoid having an excessive extra length.

The depth of the protrusion structure 10 can be, for example, 4 mm. However, the depth of the protrusion structure 10 is not limited thereto.

The depth of the protrusion structure 10 can preferably be larger than the thickness of the electric power generation element 50, and the protrusion structure 10 can preferably have an extra length in a side other than the corner portion 12. Thereby, it is possible to prevent the electric power generation element 50 from coming into contact with the exterior body 1 and improve the durability of the exterior body 1 against fatigue breakdown when expansion and contraction of the laminate battery using the exterior body 1 are repeated.

In the depth direction of the protrusion structure 10, a distance t2 between the top surface 10a of the protrusion structure 10 and the corner section 12a of the taper shape of the corner portion 12 can be preferably a height obtained by subtracting an initial height of the electric power generation element before expansion from the depth t1 of the protrusion structure 10.

A start edge of the taper shape of the corner portion 12 is the corner portion 80a of a positive electrode mixture part 80 of the electric power generation element 50.

Thereby, it is possible to prevent the end portion (the corner portion 80a of the positive electrode mixture part 80) of the electric power generation element 50 from coming into contact with the corner portion 12 of the exterior body 1 and prevent the corner portion 12 from being damaged when expansion and contraction of the laminate battery using the exterior body 1 are repeated.

The top surface 10a of the protrusion structure 10 may form a taper shape from the corner portion 80a of the positive electrode mixture part 80 of the electric power generation element 50 toward the corner portion 12 of the exterior body 1 in the side view of the protrusion structure 10. Thereby, it is possible to prevent a wrinkle from being generated on the corner portion 12 of the exterior body 1 and improve the durability of the exterior body 1 against fatigue breakdown when expansion and contraction of the laminate battery using the exterior body 1 are repeated.

### Exterior body

The exterior body 1 is a laminate film having an inner resin layer, a metal layer, and an outer resin layer. Examples of the resin that constitutes the inner resin layer and the outer resin layer include polyester resins such as polyethylene terephthalate (PET). The metal layer is constituted of, for example, an aluminum foil or the like.

### Electric power generation element

The electric power generation element 50 has a positive electrode, a negative electrode, and a solid electrolyte layer.

### Positive electrode

The positive electrode is constituted by laminating a first current collector foil and a first active material layer including at least a positive electrode active material. The first current collector foil is a current collector foil 60.

The first current collector foil can be preferably constituted of at least one material having a high conductivity.

Examples of the material having a high conductivity include a metal or an alloy containing at least one of metal elements such as silver (Ag), palladium (Pd), gold (Au), platinum (Pt), aluminum (Al), chromium (Cr), and nickel (Ni), or a non-metal such as carbon (C). In consideration of manufacturing costs in addition to the high conductivity, aluminum, nickel, or stainless steel can be preferably used. Further, aluminum is unlikely to react with the positive electrode active material and an electrolyte. Therefore, when aluminum is used for the first current collector foil, the internal resistance of the battery can be reduced.

Examples of forms of the first current collector foil can include a foil form, a plate form, a mesh form, a non-woven fabric form, a foam form, and the like. Further, in order to enhance adhesion to the first active material layer, carbon or the like may be arranged on a surface of the first current collector foil, or the surface may be coarsened.

The first active material layer includes a positive electrode active material that exchanges lithium ions and electrons. The positive electrode active material is not particularly limited as long as the positive electrode active material is a material capable of reversibly releasing and absorbing lithium ions and transferring electrons, and a known positive electrode active material that is applicable to a positive electrode of a lithium-ion battery can be used. Examples of the positive electrode active material include: composite oxides such as lithium cobalt oxide (LiCoO₂), lithium nickel oxide (LiNiO₂), lithium manganese oxide (LiMn₂O₄), solid solution oxides (Li₂MnO₃-LiMO₂ (M=Co, Ni, or the like)), lithium-manganese-nickel-cobalt oxide (LiNiₓMn_{y}Co_{z}O₂, x+y+z=1), and olivine-type lithium phosphate oxide (LiFePO₄); conductive polymers such as polyaniline and polypyrrole; sulfides such as Li₂S, CuS, Li-Cu-S compounds, TiS₂, FeS, MoS₂, and Li-Mo-S compounds; mixtures of sulfur and carbon; and the like. The positive electrode active material may be constituted of one kind of the above materials alone or may be constituted of two or more kinds thereof.

The first active material layer includes an electrolyte that exchanges lithium ions with the positive electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like.

Among these, sulfide solid electrolyte materials can be preferably used from the viewpoint of high conductivity properties of lithium ions, favorable structural formability by pressing, and favorable interfacial bonding properties.

The electrolyte may be constituted of one kind of the above materials alone or may be constituted of two or more kinds thereof.

The electrolyte included in the first active material layer may be the same material as or may be a material different from the electrolyte included in a second active material layer and the solid electrolyte layer.

The first active material layer may contain a conductive additive from the viewpoint of improvement in conductivity of the positive electrode. As the conductive additive, a conductive additive which can be generally used for a lithium-ion battery can be used.

Examples of the conductive additive can include: carbon black such as acetylene black or Ketjen black; carbon fibers; vapor grown carbon fibers; graphite powder; and carbon materials such as carbon nanotubes. The conductive additive may be constituted of one kind of the above materials alone or may be constituted of two or more kinds thereof.

Further, the first active material layer may contain a binder that plays a role in binding the positive electrode active materials to each other, and the positive electrode active material and the first current collector foil to each other.

The first current collector foil is bundled at one end portion in a width direction of the all-solid-state battery.

The first active material layer is in contact with the solid electrolyte layer and may therefore contain sulfides contained in the solid electrolyte layer.

### Negative electrode

The negative electrode is constituted by laminating a second current collector foil and a second active material layer including at least a negative electrode active material. The second current collector foil is a current collector foil 70.

The second current collector foil contains at least copper (Cu). Similarly to the first current collector foil, the second current collector foil may contain a material other than copper having a high conductivity. Examples of the material other than copper having a high conductivity include a metal or an alloy containing at least one of metal elements such as silver (Ag), palladium (Pd), gold (Au), platinum (Pt), chromium (Cr), and nickel (Ni), or a non-metal such as carbon (C). In consideration of manufacturing costs in addition to the high conductivity, nickel or stainless steel can be preferably used as the material other than copper. Further, stainless steel is unlikely to react with the positive electrode active material, the negative electrode active material, and the electrolyte. Therefore, when stainless steel is used for the second current collector foil, the manufacturing costs of the battery can be reduced.

Examples of forms of the second current collector foil can include a foil form, a plate form, a mesh form, a non-woven fabric form, a foam form, and the like. Further, in order to enhance adhesion to the second active material layer, carbon or the like may be arranged on a surface of the second current collector foil, or the surface may be coarsened.

The second active material layer includes the negative electrode active material that exchanges lithium ions and electrons. The negative electrode active material is not particularly limited as long as the negative electrode active material is a material capable of reversibly releasing and absorbing lithium ions and transferring electrons, and a known negative electrode active material that is applicable to a negative electrode of a lithium-ion battery can be used. Examples of the negative electrode active material include: carbonaceous materials such as natural graphite, artificial graphite, resin charcoal, carbon fibers, activated charcoal, hard carbon, and soft carbon; alloy-based materials mainly consisting of tin, a tin alloy, silicon, a silicon alloy, gallium, a gallium alloy, indium, an indium alloy, aluminum, an aluminum alloy, and the like; conductive polymers such as polyacene, polyacetylene, and polypyrrole; metallic lithium; and lithium alloys such as lithium-titanium composite oxides (for example, Li₄Ti₅O₁₂). These negative electrode active materials may be constituted of one kind of the above materials alone or may be constituted of two or more kinds thereof.

The second active material layer includes an electrolyte that exchanges lithium ions with the negative electrode active material. The electrolyte is not particularly limited as long as the electrolyte has lithium-ion conductivity, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based solid electrolytes containing lithium-containing salts or lithium-ion conductive ionic liquids, and the like. The electrolyte may be constituted of one kind of the above materials alone or may be constituted of two or more kinds thereof.

The electrolyte included in the second active material layer may be similar to or different from the electrolyte included in the first active material layer and the solid electrolyte layer.

The second active material layer may contain a conductive additive, a binder, and the like. These materials are not particularly limited, but, for example, materials similar to those used for the first active material layer described above can be used.

### Solid electrolyte layer

The solid electrolyte layer is arranged between the first active material layer and the second active material layer.

The electrolyte is not particularly limited as long as the electrolyte has lithium-ion conductivity and insulation properties, and a material generally used for a lithium-ion battery can be used. Examples of the electrolyte can include inorganic solid electrolytes such as sulfide solid electrolyte materials, oxide solid electrolyte materials, halide solid electrolytes, and lithium-containing salts, polymer-based solid electrolytes such as polyethylene oxide, gel-based electrolytes containing lithium-containing salts or lithium-ion conductive ionic liquids, and the like. Among these, sulfide solid electrolyte materials can be preferably used from the viewpoint of high conductivity properties of lithium ions, favorable structural formability by pressing, and favorable interfacial bonding properties.

The form of the electrolyte materials is not particularly limited, but examples of the form can include particles.

The solid electrolyte layer may contain an adhesive for imparting mechanical strength and flexibility.

The solid electrolyte layer may have a sheet shape having a porous substrate and a solid electrolyte held by the porous substrate. The form of the porous substrate described above is not particularly limited, but examples of the form include woven fabric, non-woven fabric, mesh cloth, a porous film, an expanded sheet, a punching sheet, and the like. Among these forms, non-woven fabric can be preferably used from the viewpoint of handleability in which the filling amount of a solid electrolyte can be further enhanced.

The porous substrate described above can be preferably constituted of an insulation material. Thereby, insulation properties of the solid electrolyte layer can be improved. Examples of the insulation material include: resin materials such as nylon, polyester, polyethylene, polypropylene, polytetrafluoroethylene, an ethylene-tetrafluoroethylene copolymer, polyvinylidene fluoride, polyvinylidene chloride, polyvinyl chloride, polyurethane, vinylon, polybenzimidazole, polyimide, polyphenylene sulfite, polyether ether ketone, cellulose, and an acrylic resin; natural fibers such as hemp, wood pulp, and cotton lint; glass; and the like.

According to the exterior body 1 of the present embodiment, it is possible to prevent a wrinkle from being generated on the exterior body 1 and improve the durability of the exterior body 1 against fatigue breakdown when expansion and contraction of the laminate battery using the exterior body 1 are repeated. As a result, it is possible to prevent a hole from being formed on the exterior body 1 due to the repetition of the expansion and contraction of the laminate battery using the exterior body 1.

### Laminate battery

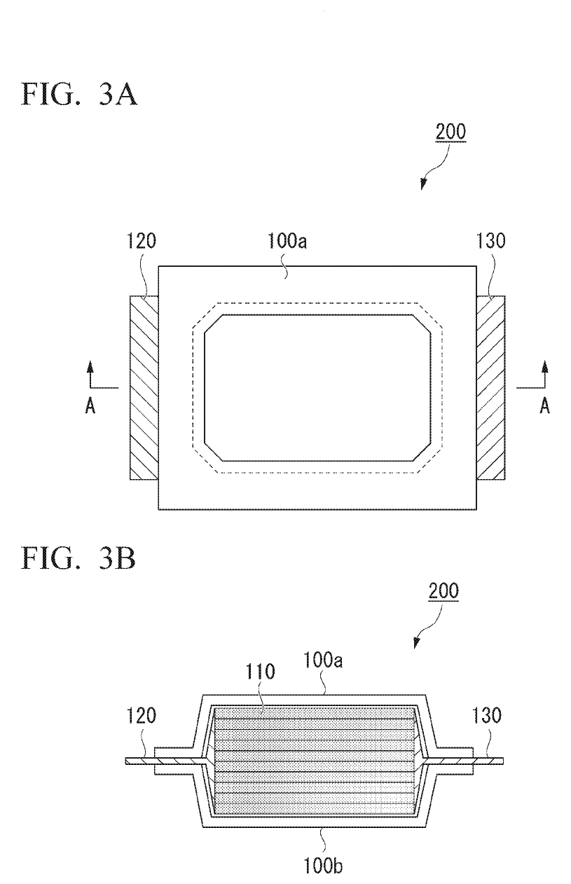

FIGS. 3A and 3B are a schematic view showing a laminate battery according to an embodiment of the present invention, FIG. 3A is a plan view, and FIG. 3B is an A-A cross-sectional view of FIG. 3A. As shown in FIGS. 3A and 3B, a laminate battery 200 of the present embodiment has a first exterior body 100a, a second exterior body 100b, an electric power generation element 110 enclosed between the first exterior body 100a and the second exterior body 100b, and a positive electrode current collector foil 120 and a negative electrode current collector foil 130 that are connected to the electric power generation element 110. Further, at least one of the first exterior body 100a and the second exterior body 100b is the exterior body 1 of the embodiment described above. Further, the electric power generation element 110 is the electric power generation element 50 in the embodiment described above.

According to the laminate battery of the present embodiment, by using the exterior body of the embodiment described above, it is possible to prevent a hole from being formed on at least one of the first exterior body 100a and the second exterior body 100b due to the repetition of the expansion and contraction of the laminate battery 200. As a result, the laminate battery 200 having high structural reliability can be obtained.

### Exterior body manufacturing method

An exterior body manufacturing method of the present embodiment is a manufacturing method of the exterior body of the embodiment described above, the exterior body manufacturing method including: a drawing process step of forming the protrusion structure described above by performing a drawing process on a laminate film, wherein a mold used for the drawing process has a shape corresponding to inclination of the top surface of the protrusion structure.

According to the present embodiment, since the mold used for the drawing process has the shape corresponding to the inclination of the top surface of the protrusion structure, it is possible to obtain an exterior body that prevents the thickness at the corner portion of the protrusion structure from being thinned.

The drawing process step in the present embodiment is a process of performing a drawing process on the laminate film and forming a protrusion structure. In the drawing process, generally, a punch is pressed against the laminate film and pushed into a die, and thereby, the protrusion structure is formed. A shape corresponding to the inclination of the top surface of the protrusion structure is formed on a corner portion of the punch. The process condition is not particularly limited, and an ordinary condition can be employed.

Although the embodiment of the present invention has been described in detail, the present invention is not limited to the embodiment described above, and various modifications and changes can be made within the scope of the gist of the present invention described in the claims.

What is claimed is:

1. An exterior body used for a laminate battery, the exterior body comprising:
a protrusion structure having a space for enclosing an electric power generation element,
wherein the protrusion structure has a top surface,
and the top surface is inclined from a corner portion of a positive electrode mixture part of the electric power generation element toward a corner portion of the exterior body in a side view of the protrusion structure.

2. The exterior body according to claim 1,
wherein a corner portion of the protrusion structure forms a taper shape, and the taper shape is inclined from the corner portion of the positive electrode mixture part of the electric power generation element toward the corner portion of the exterior body in the side view of the protrusion structure.

3. The exterior body according to claim 2,
wherein a start edge of the taper shape is the corner portion of the positive electrode mixture part of the electric power generation element.

4. The exterior body according to claim 1,
wherein the top surface forms a taper shape from the corner portion of the positive electrode mixture part of the electric power generation element toward the corner portion of the exterior body in the side view of the protrusion structure.

5. The exterior body according to claim 1,
wherein a depth of the protrusion structure is 4 mm.

6. The exterior body according to claim 1,
wherein a depth of the protrusion structure is larger than a thickness of the electric power generation element, and
the protrusion structure has an extra length in a side other than a corner portion.

7. A laminate battery having a first exterior body, a second exterior body, and an electric power generation element enclosed between the first exterior body and the second exterior body,
wherein at least one of the first exterior body and the second exterior body is the exterior body according to claim 1.

8. An exterior body manufacturing method which is a manufacturing method of the exterior body according to claim 1, the exterior body manufacturing method comprising:
forming the protrusion structure by performing a drawing process on a laminate film,
wherein a mold used for the drawing process has a shape corresponding to inclination of the top surface of the protrusion structure.
